(19) United States
(12) Patent Application Publication
(10) Pub. No.: US 2023/0186418 A1
(43) Pub. Date: Jun. 15, 2023

(54) SYSTEM AND METHOD FOR APPLYING RICARDIAN CONTRACT PRINCIPLES TO AGREEMENTS

(71) Applicants: Erich Lawson Spangenberg, Paris (FR); Kingsley Martin, Chicago, IL (US)

(72) Inventors: Erich Lawson Spangenberg, Paris (FR); Kingsley Martin, Chicago, IL (US)

(21) Appl. No.: 17/971,578

(22) Filed: Oct. 22, 2022

Related U.S. Application Data
(60) Provisional application No. 63/271,084, filed on Oct. 22, 2021.
(60) Provisional application No. 63/271,088, filed on Oct. 22, 2021.
(60) Provisional application No. 63/271,090, filed on Oct. 22, 2021.
(60) Provisional application No. 63/278,470, filed on Nov. 11, 2021.
(60) Provisional application No. 63/278,970, filed on Nov. 12, 2021.
(60) Provisional application No. 63/283,700, filed on Nov. 29, 2021.
(60) Provisional application No. 63/285,835, filed on Dec. 3, 2021.
(60) Provisional application No. 63/266,862, filed on Jan. 17, 2022.
(60) Provisional application No. 63/300,722, filed on Jan. 19, 2022.
(60) Provisional application No. 63/306,954, filed on Feb. 4, 2022.
(60) Provisional application No. 63/315,462, filed on Mar. 1, 2022.
(60) Provisional application No. 63/395,732, filed on Aug. 5, 2022.
(60) Provisional application No. 63/409,558, filed on Sep. 23, 2022.

(51) Int. Cl. G06Q 50/18

(52) U.S. Cl. CPC G06Q 50/188

(57) ABSTRACT

The present invention is a system and method that applies Ricardian Contract Principles to agreements. Ricardian contracts are designed for the hyper ledger, and are comprised of three main components: contract, metadata, and ledger. The present invention collects data from a confidentiality agreement, and can draft the agreement to ensure high accuracy in data extraction. Contract terms can be organized in a hierarchy of importance that ranks contract statement in the general order, such as: obligations; restrictions; rights; and conditional statements. The present invention tracks episodic and conditional terms, such as a monthly payment or a disclosure requiring notification. The present invention connects agreement terms to an immutable contract ledger. A ledger of contract statements associated with the events or circumstances triggering such contract obligations, restrictions, and rights processed by an immutable historical log recording all events.

### PRIORITY CLAIMS

This application claims the benefit of U.S. Provisional Pat. Application Serial Number 63/271,084, filed on Oct. 22, 2021; U.S. Provisional Pat. Application Serial Number 63/271,088, filed on Oct. 22, 2021; U.S. Provisional Pat. Application Serial Number 63/271,090, filed on Oct. 22, 2021; U.S. Provisional Pat. Application Serial Number 63/278,470, filed on Nov. 11, 2021; U.S. Provisional Pat. Application Serial Number 63/278,970, filed on Nov. 12, 2021; U.S. Provisional Pat. Application Serial Number 63/283,700, filed on Nov. 29, 2021; U.S. Provisional Pat. Application Serial Number 63/285,835, filed on Dec. 3, 2021; U.S. Provisional Pat. Application Serial Number 63/266,862, filed on Jan. 17, 2022; U.S. Provisional Pat. Application Serial Number 63/300,722, filed on Jan. 19, 2022; U.S. Provisional Pat. Application Serial Number 63/306,954, filed on Feb. 4, 2022; and U.S. Provisional Pat. Application Serial Number 63/409,558, filed on Sep. 23, 2022, all of which are incorporated herein by reference.

### FIELD OF THE INVENTION

This invention is directed to a system and method for contracts.

### BACKGROUND OF THE INVENTION

Current contract processes are very manual and expensive. More than two-thirds of the cost of contracts are administrative expenses. The excessive cost is largely attributed to high variability in contract language and the lack of standards that prevent linking contract terms with contract management and tracking systems.

### SUMMARY OF THE INVENTION

The present invention is a system and method that applies Ricardian Contract Principles to agreements, such as a Confidentiality Agreement. Ricardian contracts are designed for the hyper ledger, and are comprised of three main components: contract, metadata, and ledger. The contract is a human-readable form in declarative subject-verb-object (or actor-action-topic). Metadata is the exchange framework between the contract and the ledger. It is a term sheet that can be used to extract data from an agreement or to build a new agreement. A ledger is a machine operable form.

The present invention collects data from a confidentiality agreement, and can draft the agreement to ensure high accuracy in data extraction. This data can include: parties (names); the agreement type, such as disclosure (one-way) or exchange (mutual) of information for the intended purpose; the information scope (can be broad, specific, dated, etc.); the term, including start and end dates; the governing law; obligations, including standard of care (reasonable, adequate, strict), notice requirements (none, disclosure), and return, destruction, certification, etc.; restrictions, such as no copies or no reverse engineering; and rights, including disclosure to employees or consultants, independent development, termination on notice, and assignment (on consent, to affiliate or successor without consent).

Contract terms can be organized in a hierarchy of importance that ranks contract statement in the general order, such as: obligations; restrictions; rights; and conditional statements. The full schema has 15 levels. The present invention focuses on events that trigger contract performance, for example, obligation statements that require ongoing performance (such as confidentiality or compliance) are simply checkboxes that the contract contains such terms. They do not require any administrative activity. The present invention tracks episodic and conditional terms, such as a monthly payment or a disclosure requiring notification.

The present invention connects agreement terms to an immutable contract ledger. A ledger of contract statements associated with the events or circumstances triggering such contract obligations, restrictions, and rights processed by an immutable historical log recording all events.

The present invention uses a methodology to connect contract terms to administrative systems, including tracking and reporting process (such as payment, notifications, compliance). This methodology is focused on performance obligations, triggered by an event or circumstance, and recorded in an immutable ledger. The present invention can extract obligations and their triggering conditions from existing contracts based on contract statement classification schema. A contract term classification consists of: obligations; restrictions; and rights. This schema also consists of contract conditions and qualification, and other contract terms such as amount, dates, frequency, form, standards, and other instructions.

The present invention uses a methodology to simplify contract language to improve both human and machine readability. This can be achieved through the use of a controlled lexicon built from an analysis of existing contracts to identify standard contract language. Natural Language Processing (NLP) is used to capture contract statements, including obligations, restrictions, and rights. subject-verb-object (SVO) is used to capture actors (subjects), actions (verbs), and other information (objects), together with conditions and qualifications, including methodology to markup contract terms to capture obligations and triggering conditions. Markup language and methodology is used to normalize contract statements, conditions, etc., including methodology to render the contract and extracted terms immutable, methodology to exchange obligation data in a format that can be processed by administrative systems, and methodology to track and report contract events and external events affecting contract rights and obligations (e.g., payment, clearing, and settlement). Emails can be sent upon the occurrence of a triggering event, and the contract ledger can be updated to include a transaction log: an immutable, cryptographically verifiable transaction log recording the history of updates to the contract ledger.

The present invention is software that provides services to: create a new agreement (based on an automatically generated, editorially enhanced standard, starting with a patent license agreement); administer agreement (based on a Ricardian interface to a hyper ledger and other software applications); and manage contract portfolios (based on dashboard summaries and search features using the exported JSON data).

The present invention uses a content library to collect and analyze agreements to detect certain patterns, such as a Levenshtein distance score between clauses (e.g., the clause example and the seed clause). This analysis serves as a starting point to creating a benchmark and a new editorially enhanced clause library for the present invention.

In one embodiment, the present invention uses a defined Ricardian exchange format to summarize agreements, listing: the overall match score compared to the standard (measuring any deviation); a list of clauses used; the match score for each clause compared to the standard; the global variables and values (e.g., party names); and local variables and values (e.g., payment amount, payment date). For example, a payment clause in text form reads:
Fees and Payment. { { PARTY B}} will pay { { PARTY A}} the license fee of { {license fee} } on the { {payment day} } day on each month in immediately available funds payable to {{PARTY A}}’s with the following wire instructions:
   For credit to { {bank name and address} }, Account Number { {bank account number} }, Bank ABA Number { {Bank ABA Number} }.

In HTML/XML, the clause reads:

<ol data-clause-name=”Fees and Payment” data-clause-alt=”Monthly License”>
<li><b>Fees and Payment</b>. <span data-global-name=”Party B” data-global-
type=”text”> { {PARTY B} }</span> will pay <span data-global-name=”Party A” data-
global-type=”text”>{ {PARTY A}}</span> the license fee of <span data-local-
name=“fee” data-type=“money”>{ {license fee}}</span> on the <span data-local-
name=”payment date” data-local-type=”ordinal”> { {payment day}}</span> day of each
month in immediately available funds payable to <span data-global-name=”Party A”
data-global-type=”text”>{ {PARTY A}}</span>’s with the following wire instructions:
For credit to <span data-local-bank-name=“bank name and address” data-
type=“text”>{ {Bank Name and Address} }</span>, Account Number<span data-local-
bank-account-number=“bank account number” data-type=“text” > { {Bank Account
Number} }</span>, Bank ABA Number <span data-local-name=“Bank ABA Number”
data-type=“text”>{{Bank ABA Number} }</span>.
. </li>
</ol>

In another embodiment, the present invention makes a distinction is made between global (entire document scope) and local variables (clause scope), and validation uses the data-type attribute. This will export to the JSON format (and sent to WEip):

{
“clause”: {
“clause-id”:”xxxx”,
“clause-name”: “Fees and Payment”,
“clause-alt”:“Monthly Payment”,
“data-local-fee”: “$10,000”,
“data-local-payment-date”: “5th”,
“data-local-bank-name”: ”Bank name and address”,
“data-local-bank-account”: “Bank account number”,
“data-local-bank-routing”: “Bank routing number”
}
}

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The various embodiments are illustrated by way of example, and not by way of limitation, in the figures of the accompanying drawings. Having thus described the invention in general terms, reference will now be made to the accompanying drawings, which are not necessarily drawn to scale, and wherein:

FIG. 1 is an illustration depicting an exemplary operating environment including one or more user computers, computing devices, or processing devices, which can be used to operate a client, such as a dedicated application, web browser is shown.

FIG. 2 is another illustration depicting an exemplary operating environment including a computer system with a core processing unit and various elements as shown.

FIG. 3 is a diagram depicting the platform’s web service infrastructure.

FIG. 4 is a depiction of the platform’s web services, as well as the components of an exemplary operating environment in which embodiments of the present invention may be implemented.

FIG. 5 is an illustration of a multi-server room and the various locations in which other pertinent server rooms may exist.

FIG. 6 is a diagram outlining the web services incorporated with server-client communication.

FIG. 7 is a diagram of the flow of access between the platform of the present invention and the web services client via cloud software tools.

FIG. 8 is a diagram of an example of the cloud storage organization in which the web services accesses and retrieves user data as objects in buckets within a cloud storage space.

FIG. 9 is a line diagram illustrating a decentralized network.

FIG. 10 is a line diagram illustrating a distributed network.

FIGS. 11A-F are the use case examples of the present invention.

FIG. 12 is a diagram of a clause example of the present invention.

### DETAILED DESCRIPTION OF THE PREFERRED EMBODIMENT

The present invention is a system and method that applies Ricardian Contract Principles to agreements, such as a Confidentiality Agreement. Ricardian contracts are designed for the hyper ledger, and are comprised of three main components: contract, metadata, and ledger. The contract is a human-readable form in declarative subject-verb-object (or actor-action-topic). Metadata is the exchange framework between the contract and the ledger. It is a term sheet that can be used to extract data from an agreement or to build a new agreement. A ledger is a machine operable form.

The present invention collects data from a confidentiality agreement, and can draft the agreement to ensure high accuracy in data extraction. This data can include: parties (names); the agreement type, such as disclosure (one-way) or exchange (mutual) of information for the intended purpose; the information scope (can be broad, specific, dated, etc.); the term, including start and end dates; the governing law; obligations, including standard of care (reasonable, adequate, strict), notice requirements (none, disclosure), and return, destruction, certification, etc.; restrictions, such as no copies or no reverse engineering; and rights, including disclosure to employees or consultants, independent development, termination on notice, and assignment (on consent, to affiliate or successor without consent).

Contract terms can be organized in a hierarchy of importance that ranks contract statement in the general order, such as: obligations; restrictions; rights; and conditional statements. The full schema has 15 levels. The present invention focuses on events that trigger contract performance, for example, obligation statements that require ongoing performance (such as confidentiality or compliance) are simply checkboxes that the contract contains such terms. They do not require any administrative activity. The present invention tracks episodic and conditional terms, such as a monthly payment or a disclosure requiring notification.

The present invention connects agreement terms to an immutable contract ledger. A ledger of contract statements associated with the events or circumstances triggering such contract obligations, restrictions, and rights processed by an immutable historical log recording all events.

The present invention uses a methodology to connect contract terms to administrative systems, including tracking and reporting process (such as payment, notifications, compliance). This methodology is focused on performance obligations, triggered by an event or circumstance, and recorded in an immutable ledger. The present invention can extract obligations and their triggering conditions from existing contracts based on contract statement classification schema. A contract term classification consists of: obligations; restrictions; and rights. This schema also consists of contract conditions and qualification, and other contract terms such as amount, dates, frequency, form, standards, and other instructions.

The present invention uses a methodology to simplify contract language to improve both human and machine readability. This can be achieved through the use of a controlled lexicon built from an analysis of existing contracts to identify standard contract language. Natural Language Processing (NLP) is used to capture contract statements, including obligations, restrictions, and rights. subject-verb-object (SVO) is used to capture actors (subjects), actions (verbs), and other information (objects), together with conditions and qualifications, including methodology to markup contract terms to capture obligations and triggering conditions. Markup language and methodology is used to normalize contract statements, conditions, etc., including methodology to render the contract and extracted terms immutable, methodology to exchange obligation data in a format that can be processed by administrative systems, and methodology to track and report contract events and external events affecting contract rights and obligations (e.g., payment, clearing, and settlement). Emails can be sent upon the occurrence of a triggering event, and the contract ledger can be updated to include a transaction log: an immutable, cryptographically verifiable transaction log recording the history of updates to the contract ledger.

The present invention is software that provides services to: create a new agreement (based on an automatically generated, editorially enhanced standard, starting with a patent license agreement); administer agreement (based on a Ricardian interface to a hyper ledger and other software applications); and manage contract portfolios (based on dashboard summaries and search features using the exported JSON data).

The present invention uses a content library to collect and analyze agreements to detect certain patterns, such as a Levenshtein distance score between clauses (e.g., the clause example and the seed clause). This analysis serves as a starting point to creating a benchmark and a new editorially enhanced clause library for the present invention.

In one embodiment, the present invention uses a defined Ricardian exchange format to summarize agreements, listing: the overall match score compared to the standard (measuring any deviation); a list of clauses used; the match score for each clause compared to the standard; the global variables and values (e.g., party names); and local variables and values (e.g., payment amount, payment date). For example, a payment clause in text form reads:
Fees and Payment. { { PARTY B}} will pay { { PARTY A}} the license fee of { {license fee} } on the { {payment day} } day on each month in immediately available funds payable to {{PARTY A}}’s with the following wire instructions:
   For credit to { {bank name and address} }, Account Number { {bank account number} }, Bank ABA Number { {Bank ABA Number} }.

In HTML/XML, the clause reads:

<ol data-clause-name=”Fees and Payment” data-clause-alt=”Monthly License”>
<li><b>Fees and Payment</b>. <span data-global-name=”Party B” data-global-
type=”text”>{ { PARTY B}}</span> will pay <span data-global-name=”Party A” data-
global-type=”text”>{ {PARTY A}}</span> the license fee of <span data-local-
name=“fee” data-type=“money”>{ {license fee}}</span> on the <span data-local-
name=”payment date” data-local-type=”ordinal”> { {payment day}}</span> day of each
month in immediately available funds payable to <span data-global-name=”Party A”
data-global-type=”text”>{ {PARTY A}}</span>’s with the following wire instructions:
For credit to <span data-local-bank-name=“bank name and address” data-
type=“text”>{ {Bank Name and Address} }</span>, Account Number<span data-local-
bank-account-number=“bank account number” data-type=“text” > { {Bank Account
Number} }</span>, Bank ABA Number <span data-local-name=“Bank ABA Number”
data-type=“text”> { {Bank ABA Number} }</span>.
.</li>
</ol>

In another embodiment, the present invention makes a distinction is made between global (entire document scope) and local variables (clause scope), and validation uses the data-type attribute. This will export to the JSON format (and sent to WEip):

{
“clause”: {
“clause-id” :”xxxx”,
“clause-name”: “Fees and Payment”,
“clause-alt”:“Monthly Payment”,
“data-local-fee”: “$10,000”,
“data-local-payment-date”: “5th”,
“data-local-bank-name”: “Bank name and address”,
“data-local-bank-account”: “Bank account number”,
“data-local-bank-routing”: “Bank routing number”
}
}

The present invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents.

Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

The units described above can be implemented as software components executing on one or more general purpose processors, as hardware such as programmable logic devices and/or Application Specific Integrated Circuits designed to perform certain functions or a combination thereof. In some embodiments, the units can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The units may be implemented on a single device or distributed across multiple devices. The functions of the units may be merged into one another or further split into multiple sub-units.

The methods or algorithmic steps described in light of the embodiments disclosed herein can be implemented using hardware, processor-executed software modules, or combinations of both. Software modules can be installed in random-access memory (RAM), memory, read-only memory (ROM), electrically programmable ROM, electrically erasable programmable ROM, registers, hard drives, removable disks, CD-ROM, or any other forms of storage media known in the technical field.

Persons of ordinary skill in the art are able to understand that all or portions of the steps in the embodiments described above may be realized using programs instructing the relevant hardware, and said programs can be stored on computer-readable storage media, such as a read-only memory, hard disk or compact disc. Optionally, all or portions of the steps of the embodiments described above may also be realized using one or multiple integrated circuits. Accordingly, the various modules/units contained in the embodiments above may also be realized in the form of hardware or software function modules. Thus, the present application is not limited to any specific combination of hardware and software.

The present application may have a variety of other embodiments and, without departing from the spirit and substance of the present application, persons skilled in the art may produce a variety of corresponding changes and modifications based on the present application, but these corresponding changes and modifications shall all fall within the scope of protection of the claims of this application.

Although the foregoing embodiments have been described in some detail for purposes of clarity of understanding, the invention is not limited to the details provided. There are many alternative ways of implementing the invention. The disclosed embodiments are illustrative and not restrictive.

While the invention has been described in detail and with reference to specific embodiments thereof, it will be apparent to those skilled in the art that various changes and modifications can be made therein without departing from the spirit and scope thereof. Thus, it is intended that the present invention cover the modifications and variations of this invention provided they come within the scope of the appended claims and their equivalents.

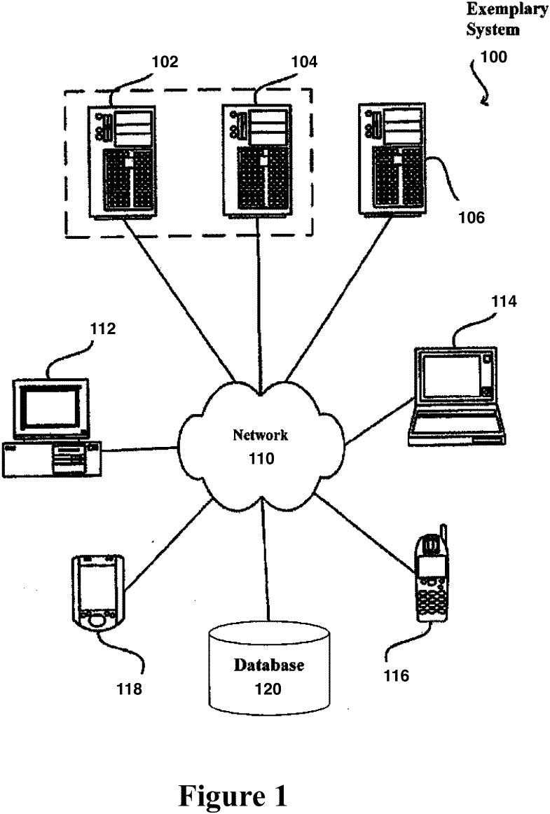

FIG. 1 is a block diagram illustrating components of an exemplary operating environment in which embodiments of the present invention may be implemented. The system 100 can include one or more user computers, computing devices, or processing devices 112, 114, 116, 118, which can be used to operate a client, such as a dedicated application, web browser, etc. The user computers 112, 114, 116, 118 can be general purpose personal computers (including, merely by way of example, personal computers and/or laptop computers running a standard operating system), cell phones or PDAs (running mobile software and being Internet, e-mail, SMS, Blackberry, or other communication protocol enabled), and/or workstation computers running any of a variety of commercially-available UNIX or UNIX-like operating systems (including without limitation, the variety of GNU/Linux operating systems). These user computers 112, 114, 116, 118 may also have any of a variety of applications, including one or more development systems, database client and/or server applications, and Web browser applications. Alternatively, the user computers 112, 114, 116, 118 may be any other electronic device, such as a thin-client computer, Internet- enabled gaming system, and/or personal messaging device, capable of communicating via a network (e.g., the network 110 described below) and/or displaying and navigating Web pages or other types of electronic documents. Although the exemplary system 100 is shown with four user computers, any number of user computers may be supported.

In most embodiments, the system 100 includes some type of network 110. The network can be any type of network familiar to those skilled in the art that can support data communications using any of a variety of commercially-available protocols, including without limitation TCP/IP, SNA, IPX, AppleTalk, and the like. Merely by way of example, the network 110 can be a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, GRPS, GSM, UMTS, EDGE, 2G, 2.5G, 3G, 4G, Wimax, WiFi, CDMA 2000, WCDMA, the Bluetooth protocol known in the art, and/or any other wireless protocol); and/or any combination of these and/or other networks.

The system may also include one or more server computers 102, 104, 106 which can be general purpose computers, specialized server computers (including, merely by way of example, PC servers, UNIX servers, mid-range servers, mainframe computers rack-mounted servers, etc.), server farms, server clusters, or any other appropriate arrangement and/or combination. One or more of the servers (e.g., 106) may be dedicated to running applications, such as a business application, a Web server, application server, etc. Such servers may be used to process requests from user computers 112, 114, 116, 118. The applications can also include any number of applications for controlling access to resources of the servers 102, 104, 106.

The Web server can be running an operating system including any of those discussed above, as well as any commercially-available server operating systems. The Web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers 112, 114, 116, 118. As one example, a server may execute one or more Web applications. The Web application may be implemented as one or more scripts or programs written in any programming language, such as Java.RTM., C, C# or C++, and/or any scripting language, such as Perl, Python, or TCL, as well as combinations of any programming/scripting languages. The server(s) may also include database servers, including without limitation those commercially available from Oracle.RTM., Microsoft.RTM., Sybase.RTM., IBM.RTM. and the like, which can process requests from database clients running on a user computer 112, 114, 116, 118.

The system 100 may also include one or more databases 120. The database(s) 120 may reside in a variety of locations. By way of example, a database 120 may reside on a storage medium local to (and/or resident in) one or more of the computers 102, 104, 106, 112, 114, 116, 118. Alternatively, it may be remote from any or all of the computers 102, 104, 106, 112, 114, 116, 118, and/or in communication (e.g., via the network 110) with one or more of these. In a particular set of embodiments, the database 120 may reside in a storage-area network (“SAN”) familiar to those skilled in the art. Similarly, any necessary files for performing the functions attributed to the computers 102, 104, 106, 112, 114, 116, 118 may be stored locally on the respective computer and/or remotely, as appropriate. In one set of embodiments, the database 120 may be a relational database, such as Oracle 10 g, that is adapted to store, update, and retrieve data in response to SQL-formatted commands.

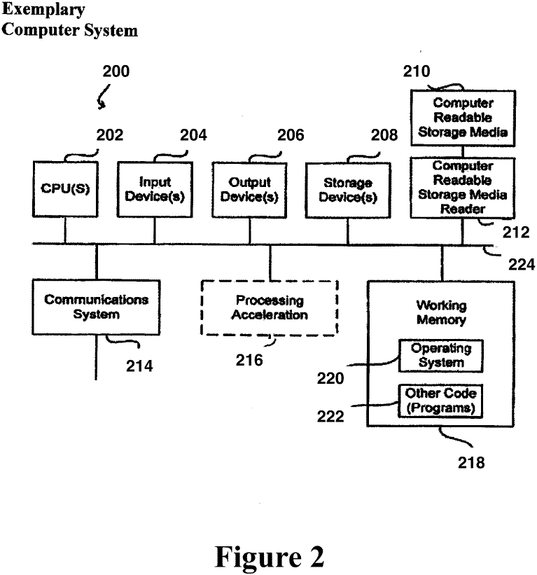

FIG. 2 illustrates an exemplary computer system 200, in which embodiments of the present invention may be implemented. The system 200 may be used to implement any of the computer systems described above. The computer system 200 is shown comprising hardware elements that may be electrically coupled via a bus 224. The hardware elements may include one or more central processing units (CPUs) 202, one or more input devices 204 (e.g., a mouse, a keyboard, etc.), and one or more output devices 206 (e.g., a display device, a printer, etc.). The computer system 200 may also include one or more storage devices 208. By way of example, the storage device(s) 208 can include devices such as disk drives, optical storage devices, solid- state storage device such as a random access memory (“RAM”) and/or a read-only memory (“ROM”), which can be programmable, flash-updateable and/or the like.

The computer system 200 may additionally include a computer-readable storage media reader 212, a communications system 214 (e.g., a modem, a network card (wireless or wired), an infra-red communication device, etc.), and working memory 218, which may include RAM and ROM devices as described above. In some embodiments, the computer system 200 may also include a processing acceleration unit 216, which can include a digital signal processor DSP, a special-purpose processor, and/or the like.

The computer-readable storage media reader 212 can further be connected to a computer-readable storage medium 210, together (and, optionally, in combination with storage device(s) 208) comprehensively representing remote, local, fixed, and/or removable storage devices plus storage media for temporarily and/or more permanently containing, storing, transmitting, and retrieving computer-readable information. The communications system 214 may permit data to be exchanged with the network and/or any other computer described above with respect to the system 200.

The computer system 200 may also comprise software elements, shown as being currently located within a working memory 218, including an operating system 220 and/or other code 222, such as an application program (which may be a client application, Web browser, mid-tier application, RDBMS, etc.). It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and nonremovable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, data signals, data transmissions, or any other medium which can be used to store or transmit the desired information and which can be accessed by the computer. Based on the disclosure and teachings provided herein, a person of ordinary skill in the art will appreciate other ways and/or methods to implement the various embodiments.

As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

FIG. 2 further illustrates an environment where an on-demand distributed database service might be used. As illustrated in FIG. 2 user systems might interact via a network with an on-demand database. Some on-demand databases may store information from one or more records stored into tables of one or more distributed database images to form a database management system (DBMS). Accordingly, on- demand database and system will be used interchangeably herein. A database image may include one or more database objects. A relational database management system (RDMS) or the equivalent may execute storage and retrieval of information against the database object(s). Some on-demand database services may include an application platform that enables creation, managing and executing one or more applications developed by the provider of the on-demand database service, wherein users accesses the on-demand database service via user systems, or third party application developers access the on-demand database service via user systems.

The security of a particular user system might be entirely determined by permissions (permission levels) for the current user. For example, where a user account identification transaction may involve a portable identification alpha-numeric data field physically or digitally linked to a personal primary identification device to request services from a provider account and wherein the user is using a particular user system to interact with System, that user system has the permissions allotted to that user account. However, while an administrator is using that user system to interact with System, that user system has the permissions allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different permissions with regard to accessing and modifying application and database information, depending on a user’s security or permission level.

A network can be a LAN (local area network), WAN (wide area network), wireless network, point-to-point network, star network, token ring network, hub network, or other appropriate configuration. As the most common type of network in current use is a TCP/IP (Transfer Control Protocol and Internet Protocol) network such as the global internetwork of networks often referred to as the “Internet” with a capital “I,” that will be used in many of the examples herein. However, it should be understood that the networks that the present invention might use are not so limited, although TCP/IP is a frequently implemented protocol.

User systems might communicate with a system using TCP/IP and, at a higher network level, use other common Internet protocols to communicate, such as HTTP, FTP, AFS, WAP, etc. In an example where HTTP is used, a user system might include an HTTP client commonly referred to as a “browser” for sending and receiving HTTP messages to and from an HTTP server at System. Such HTTP server might be implemented as the sole network interface between a system and network, but other techniques might be used as well or instead. In some implementations, the interface between a system and network includes load sharing functionality, such as round-robin HTTP request distributors to balance loads and distribute incoming HTTP requests evenly over a plurality of servers. At least as for the users that are accessing that server, each of the plurality of servers has access to at least one third party entity system data schema; however, other alternative configurations are contemplated.

According to one arrangement, each user system and all of its components are operator configurable using applications, such as a browser, including computer code run using a central processing unit such as an Intel Pentium.RTM. processor or the like. Similarly, a computer system (and additional instances of an enterprise database, where more than one is present) and all of their components might be operator configurable using application(s) including computer code run using a central processing unit such as an Intel Pentium.RTM. processor or the like, or multiple processor units. A computer program product aspect includes a machine-readable storage medium (media) having instructions stored thereon/in which can be used to program a computer to perform any of the processes of the embodiments described herein. Computer code for operating and configuring systems to intercommunicate and to process web pages, applications and other data and media content as described herein is preferably downloaded and stored on a hard disk, but the entire program code, or portions thereof, may also be locally stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing aspects of the present invention can be implemented in any programming language that can be executed on a client system and/or server or server system such as, for example, in C, C++, HTML, any other markup language, Java.TM., JavaScript, ActiveX, any other scripting language such as VBScript, and many other programming languages as are well known. (Java.TM. is a trademark of Sun Microsystems, Inc.).

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a non-transitory computer readable medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CDROM, CDR, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

The present technology requires a data processing system with sufficient memory and processing power to store and recall user data in real time. In addition, the invention may be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups.

As before, the blocks may be representative of modules that are configured to provide represented functionality. Further, any of the functions described herein can be implemented using software, firmware (e.g., fixed logic circuitry), manual processing, or a combination of these implementations. The terms “module,” “functionality,” and “logic” as used herein generally represent software, firmware, hardware or a combination thereof. In the case of a software implementation, the module, functionality, or logic represents program code that performs specified tasks when executed on a processor (e.g., CPU or CPUs). The program code can be stored in one or more computer readable memory devices. The features of the techniques described above are platform-independent, meaning that the techniques may be implemented on a variety of commercial computing platforms having a variety of processors.

Encoding the software presented herein, also transform the physical structure of the computer readable media presented herein. The specific transformation of physical structure depends on various factors, in different implementations of this description. Examples of such factors include, but are not limited to, the technology used to implement the computer readable media, whether the computer readable media is characterized as primary or secondary storage, and the like. For example, if the computer readable media is implemented as semiconductor-based memory, the software disclosed herein can be encoded on the computer readable media by transforming the physical state of the semiconductor memory. For instance, the software can transform the state of transistors, capacitors, or other discrete circuit elements constituting the semiconductor memory. The software can also transform the physical state of such components in order to store data thereupon.

As another example, the computer readable media disclosed herein can be implemented using magnetic or optical technology. In such implementations, the software components presented herein can transform the physical state of magnetic or optical media, when the software is encoded therein. These transformations can include altering the magnetic characteristics of particular locations within given magnetic media. These transformations can also include altering the physical features or characteristics of particular locations within given optical media, to change the optical characteristics of those locations. Other transformations of physical media are possible without departing from the scope and spirit of the present description, with the foregoing examples provided only to facilitate this discussion.

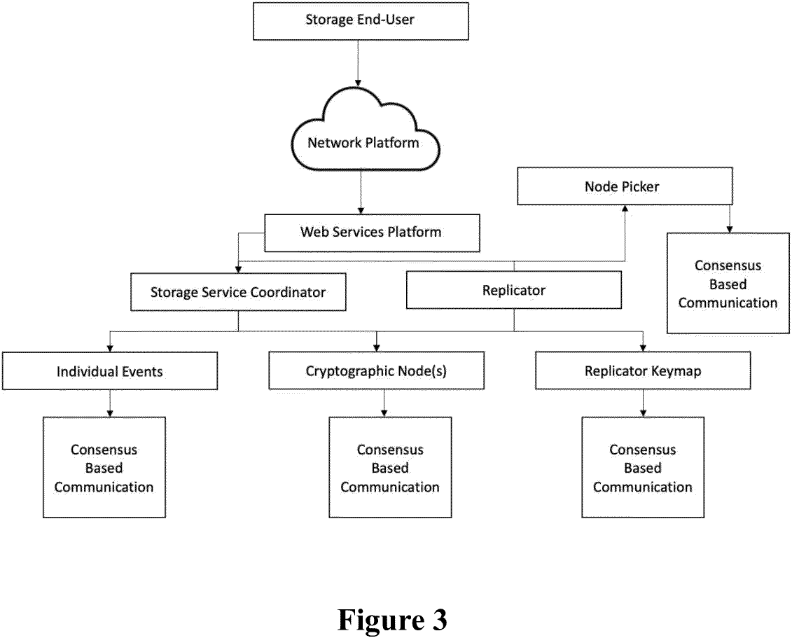

FIG. 3 is a diagram showing the communication between the storage end users, the network platform and the various elements that help effectuate operations. The storage end user communicates and relays various pertinent bits of data to the network platform. The network platform operates on the web service platform, which features a storage service coordinator and replicator. Each of these services utilize a node picker which helps establish consensus-based communication. The storage service coordinator maintains and records individual events and cryptographic nodes, or keys that are used for operations. The replicator has its own keymap which generates consensus-based communication, alongside the cryptographic nodes and individual events.

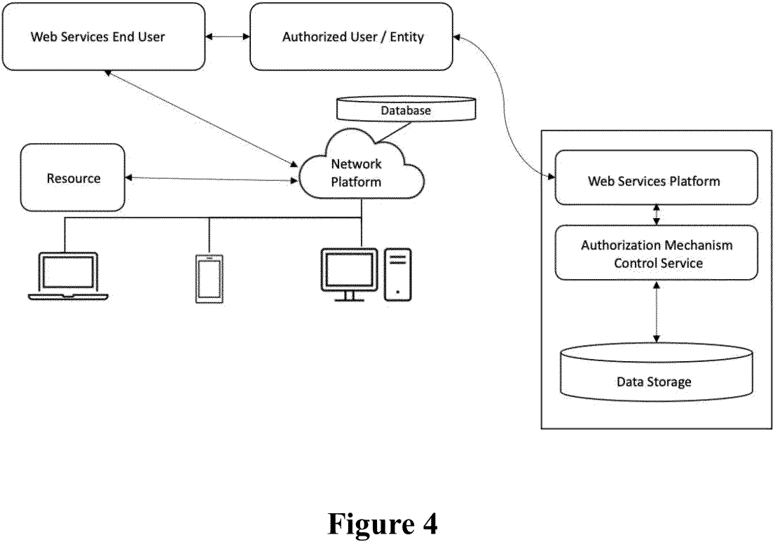

FIG. 4 is a diagram showing the web services of the platform and system. The platform and system are all components of an exemplary operating environment in which embodiments of the present invention may be implemented. The system can include one or more user computers, computing devices, or processing devices which can be used to operate a client, such as a dedicated application, web browser, etc. The user computers can be general purpose personal computers (including, merely by way of example, personal computers and/or laptop computers running a standard operating system), cell phones or PDAs (running mobile software and being Internet, e-mail, SMS, Blackberry, or other communication protocol enabled), and/or workstation computers running any of a variety of commercially-available UNIX or UNIX-like operating systems (including without limitation, the variety of GNU/Linux operating systems). These user computers may also have any of a variety of applications, including one or more development systems, database client and/or server applications, and Web browser applications. Alternatively, the user computers may be any other electronic device, such as a thin-client computer, Internet- enabled gaming system, and/or personal messaging device, capable of communicating via a network (e.g., the network described below) and/or displaying and navigating Web pages or other types of electronic documents. Although the exemplary system is shown with four user computers, any number of user computers may be supported.

In most embodiments, the system includes some type of network. The network can be any type of network familiar to those skilled in the art that can support data communications using any of a variety of commercially-available protocols, including without limitation TCP/IP, SNA, IPX, AppleTalk, and the like. Merely by way of example, the network can be a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, GRPS, GSM, UMTS, EDGE, 2G, 2.5G, 3G, 4G, WiMAX, WiFi, CDMA 2000, WCDMA, the Bluetooth protocol known in the art, and/or any other wireless protocol); and/or any combination of these and/or other networks.

The system may also include one or more server computers which can be general purpose computers, specialized server computers (including, merely by way of example, PC servers, UNIX servers, mid-range servers, mainframe computers rack-mounted servers, etc.), server farms, server clusters, or any other appropriate arrangement and/or combination. One or more of the servers may be dedicated to running applications, such as a business application, a Web server, application server, etc. Such servers may be used to process requests from user computers. The applications can also include any number of applications for controlling access to resources of the servers.

The Web server can be running an operating system including any of those discussed above, as well as any commercially-available server operating systems. The Web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers. As one example, a server may execute one or more Web applications. The Web application may be implemented as one or more scripts or programs written in any programming language, such as Java.RTM., C, C#, or C++, and/or any scripting language, such as Perl, Python, or TCL, as well as combinations of any programming/scripting languages. The server(s) may also include database servers, including without limitation those commercially available from Oracle.RTM., Microsoft.RTM., Sybase.RTM., IBM.RTM. and the like, which can process requests from database clients running on a user computer.

End users, or users that are viewing and using the network platform, all contribute data to the cloud. A web service platform helps secure that data and maintain the service’s functionalities. Only authorized users and entities can authorize or unauthorize content and monitor data stored within the web service. The platform’s web services help maintain the operations of elements managed by the storage system.

The system may also include one or more databases. The database(s) may reside in a variety of locations. By way of example, a database 620 may reside on a storage medium local to (and/or resident in) one or more of the computers. Alternatively, it may be remote from any or all of the computers, and/or in communication (e.g., via the network) with one or more of these. In a particular set of embodiments, the database may reside in a storage-area network (“SAN”) familiar to those skilled in the art. Similarly, any necessary files for performing the functions attributed to the computers may be stored locally on the respective computer and/or remotely, as appropriate. In one set of embodiments, the database may be a relational database, such as Oracle 10 g, that is adapted to store, update, and retrieve data in response to SQL-formatted commands.

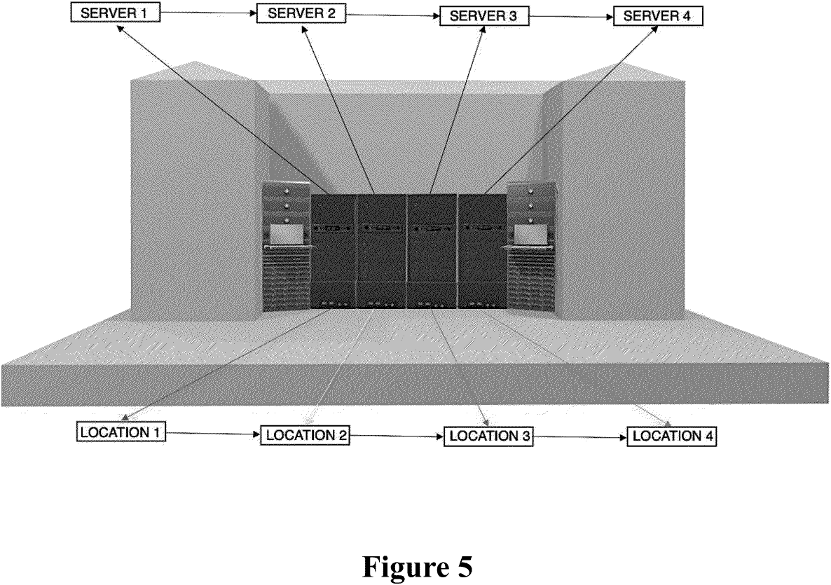

FIG. 5 is an illustration of server-to-server connections, within a server room and to other sever room locations. The web server undergoes an initialization process and features a database of wireless network data. Dependent on the service requested, the data may undergo processing. The servers actively attempt to retrieve the appropriate data to provide user input. Data may then be formatted, and with the appropriate authorizations, saved or restructured.

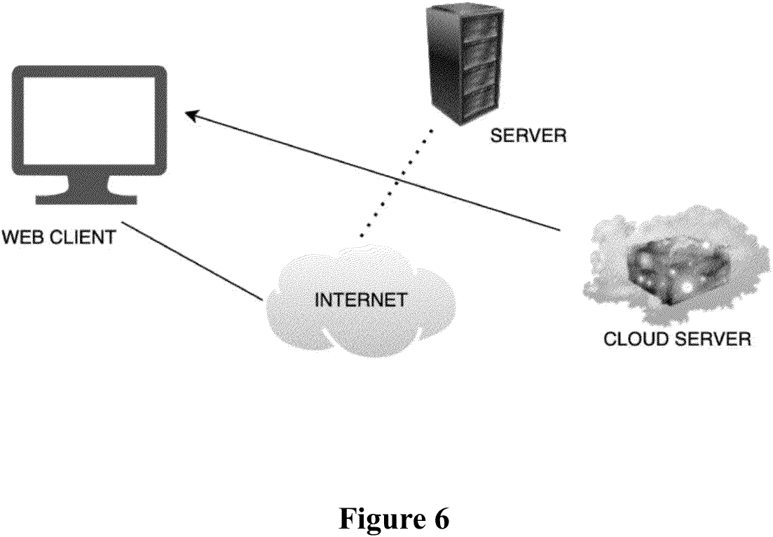

FIG. 6 is a diagram outlining the role of web services in the present invention. In accordance with the preferred embodiment, a web client interacts with the server ecosystem by way of a service connection, such as the internet, which then distributes data and pertinent information such as the web service platform to the cloud server and preliminary servers. This allows for data to be streamlined between the client and the server as well as cloud servers and other database systems. Communication between web services may be completed via Simple Object Access Protocol (SOAP) which allows multiple web service applications to communicate rapidly and efficiently and to provide data to the web client.

The infrastructure of the present invention also allows for the use of web services that enable interaction with and storage of data across devices. Specifically, these web services can allow for the use of cloud software tools and cloud-based data storage. Cloud software tools can be used to allow for increased user authentication and authorization checkpoints for data accessed between parties. The web service software aids in the transmission of data between entities while still maintaining secure access restrictions preventing any unauthorized access to the cloud data.

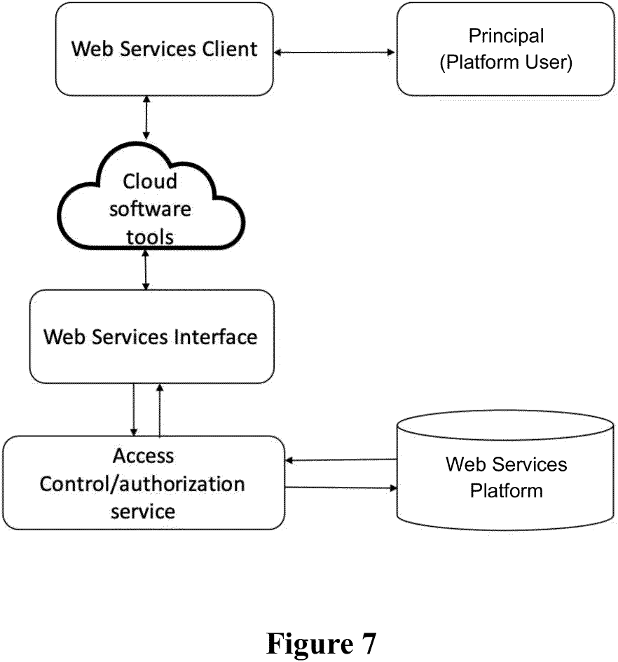

FIG. 7 is a diagram of the flow of access between the platform of the present invention and the web services client via cloud software tools. The principal or platform user accesses the web services client, which then transmits data via cloud software tools to the web services interface. Access control and authorization acts as a layer in order to access the web services platform by way of the web services interface.

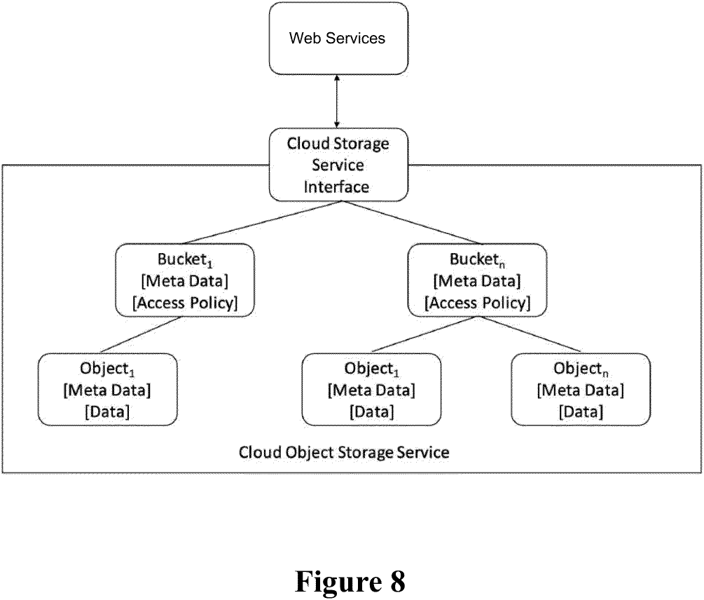

FIG. 8 is a diagram of an example of the cloud storage organization in which the web services accesses and retrieves user data as objects in buckets within a cloud storage space. The cloud storage service is a means of storing and protecting any amount of data for a range of use cases. A bucket is a container for objects stored in the cloud storage service, and objects consist of object data and metadata. The metadata is a set of name-value pairs that describe the object. These pairs include some default metadata, such as the date last modified, and standard HTTP metadata, such as Content-Type. You can also specify custom metadata at the time that the object is stored. Web services provide access to and from the cloud object storage service via the cloud storage service interface.

The present invention utilizes key aspects of blockchain technology. Blockchain technology uses digital fingerprints, version control and a distributed ledger to provide an immutable notary through a distributed asset ledger. Digital fingerprints incorporate time stamps on files to eliminate potential file tampering. Version control provides a means of connecting multiple iterations of files together using the same fingerprints. A distributed ledger provides a secure means of recording an immutable record to facilitate the transfer of funds between parties. Blockchain technology provides enterprise transaction support through smart contracts and a permission ledger. Smart contracts provide a means of attaching events and conditions to a transaction on the distributed ledger, and a permission ledger applies technology to global business transactions with privacy and better performance. Blockchain technology acts as a network of networks within a market, resulting in building trusted data and networks that operate at the level of the market.

By applying blockchain technology at the market level, the present invention transforms how IP assets are obtained, managed and transacted. Permissioned Blockchain allows multiple competing parties to operate from the same common database without revealing their data to the other party via the following means: trust, as the ledger keeps an immutable record of IP assets with rules governing who can update the records & how; control, as no central authority has access to all data on the network, the network is instead governed by rules; and privacy, through data and events that are made private and are both invisible and inaccessible to users who do not have authorization.

The present invention transforms how IP is obtained, managed and transacted by applying blockchain technology at the market level. Through blockchain technology, the present invention captures all IP asset events, whereby every party works from same record and titles are tracked. Each event for an IP asset is written to the blockchain, and rules dictate what data can be updated & how. All parties work from the same IP asset record and each change in ownership is a blockchain event. Parties have a secure environment where they can interact & transact on IP assets through: a private network channel for parties to interact; management of activity for both parties within the same location; data that can be shared safely over a private network; and paper contracts automated through smart contracts.

The permissioned blockchain network of the present invention fosters trust and globally improves cross border transactions. The blockchain network can be deployed globally, and only verified members are given access to the network. All parties can connect to a single platform and blockchain removes cross border cost & complexity. The present invention utilizes blockchain technology to capture the invention and introduce flexibility in how IP is stored & protected. Blockchain provides proof of inventorship and set up partnerships earlier once application is filed. Research is connected to the final patent and the present invention provides a secure platform for R&D and IP to work more closely.

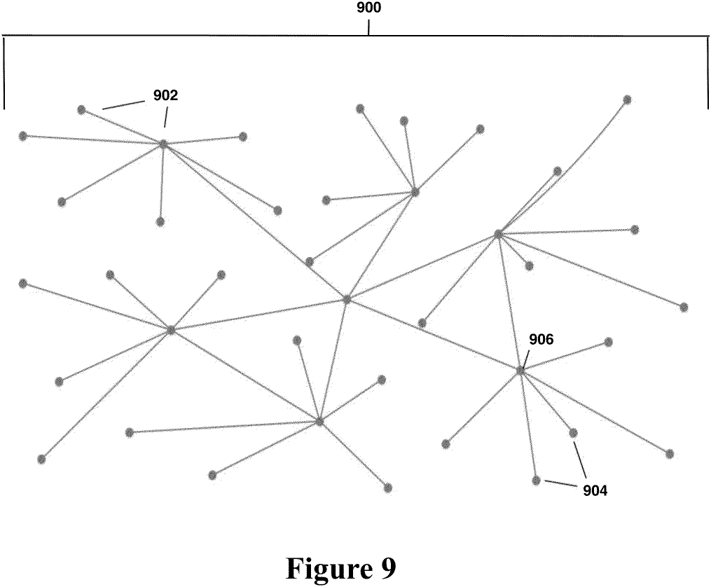

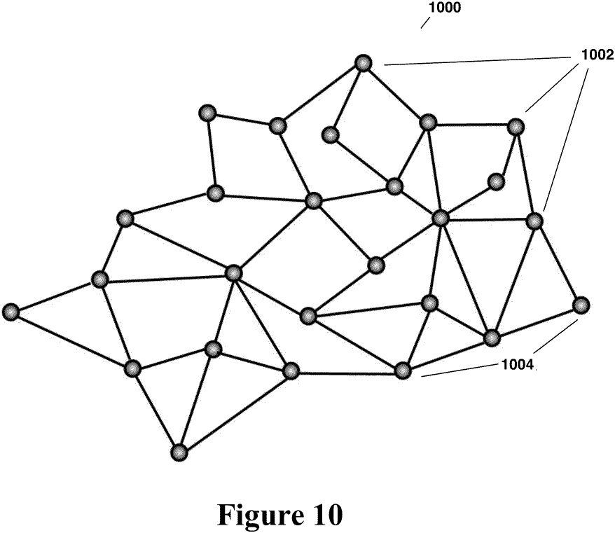

FIG. 9 is a line diagram illustrating a decentralized network. In accordance with the preferred embodiment of the present invention, the specific architecture of the network can be either decentralized or distributed. FIG. 9, generally represented by the numeral 900, provides an illustrative diagram of the decentralized network. FIG. 9 depicts each node with a dot 902 Under this system, each node is connected to at least one other node 904. Only some nodes are connected to more than one node 906.

FIG. 10 is a line diagram illustrating a distributed network. For comparison purposes, FIG. 10, which is generally represented by the numeral 1000, illustrates a distributed network. Specifically, the illustration shows the interconnection of each node 1002 in a distributed decentralized network 1000. In accordance with the preferred embodiment of the present invention, each node 1002 in the distributed network 1000 is directly connected to at least two other nodes 1004. This allows each node 1002 to transact with at least one other node 1002 in the network. The present invention can be deployed on a centralized, decentralized, or distributed network.

In one embodiment, each transaction (or a block of transactions) is incorporated, confirmed, verified, included, or otherwise validated into the blockchain via a consensus protocol. Consensus is a dynamic method of reaching agreement regarding any transaction that occurs in a decentralized system. In one embodiment, a distributed hierarchical registry is provided for device discovery and communication. The distributed hierarchical registry comprises a plurality of registry groups at a first level of the hierarchical registry, each registry group comprising a plurality of registry servers. The plurality of registry servers in a registry group provide services comprising receiving client update information from client devices, and responding to client lookup requests from client devices. The plurality of registry servers in each of the plurality of registry groups provide the services using, at least in part, a quorum consensus protocol.

As another example, a method is provided for device discovery and communication using a distributed hierarchical registry. The method comprises Broadcasting a request to identify a registry server, receiving a response from a registry server, and sending client update information to the registry server. The registry server is part of a registry group of the distributed hierarchical registry, and the registry group comprises a plurality of registry servers. The registry server updates other registry servers of the registry group with the client update information using, at least in part, a quorum consensus protocol.

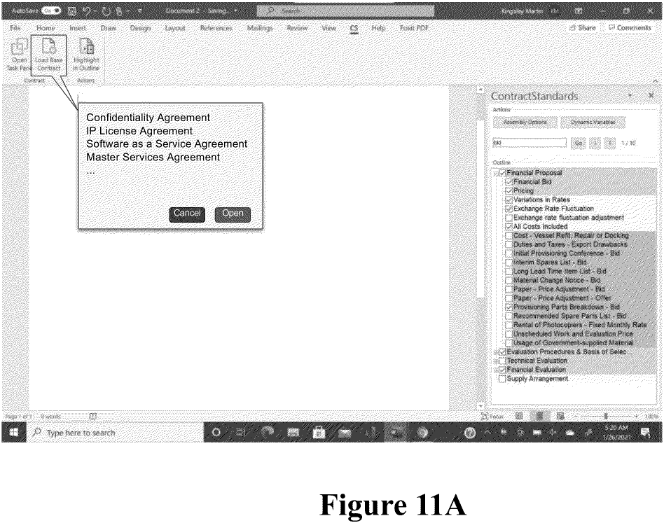

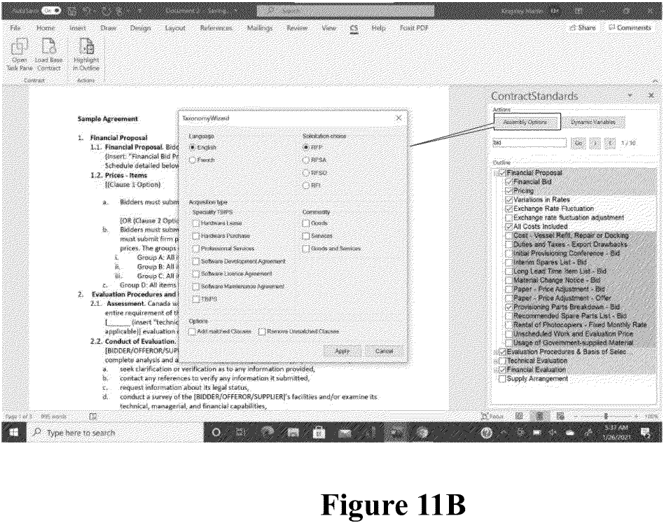

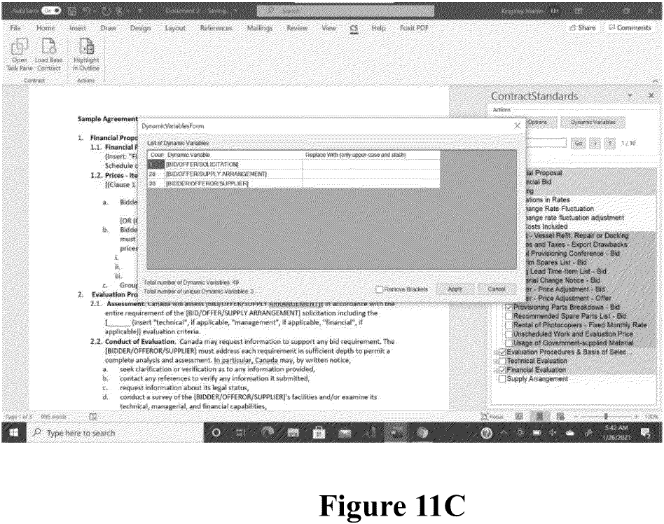

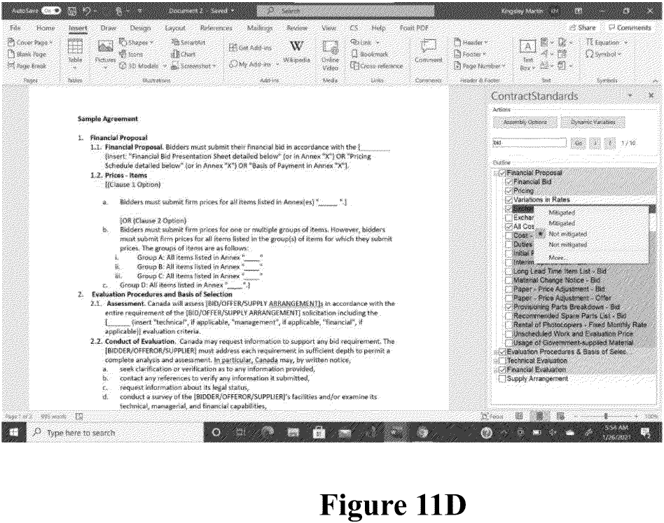

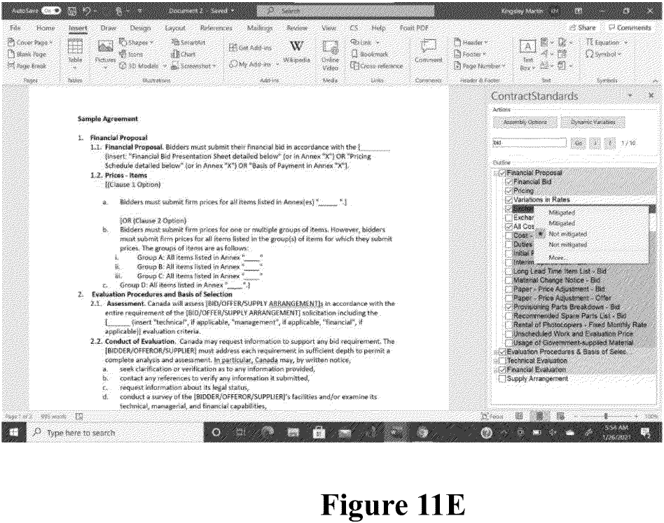

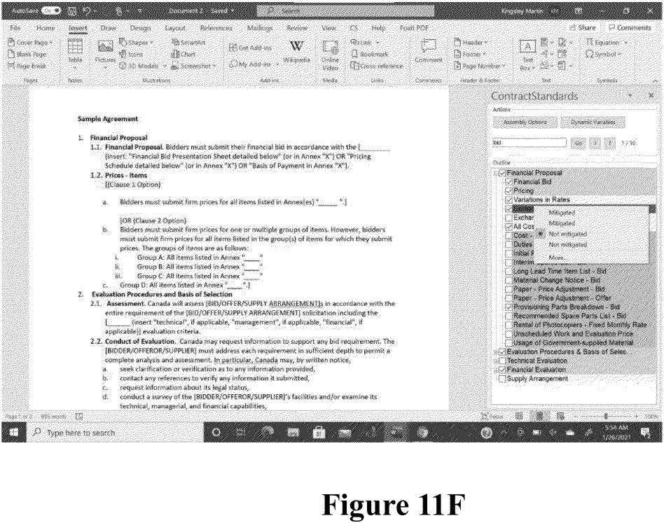

FIGS. 11A-F are the use case examples of the present invention. FIG. 11A shows the initial process of loading the template from the server, which requires user authentication to access only the templates that the user is authorized to view. The templates are stamped with the version and date, and stored with the user’s document. If there is an updated version available, the user receives a notification as well as a listing of the template terms that have been changed or updated.

FIG. 11B shows the process of assembling the agreement based on clause tags. Clause types may be filtered and may also be color coded, for example: required (gray); standard (green); optional (yellow); and deal-specific (blue). FIG. 11C shows the process of setting dynamic variables. For example, global variables may be shown in ALL CAPS text surrounded by square brackets, or may be changed to parenthesis, and local variables text may be surrounded by brackets and may be used to adjust clause specific information. Global and local variables are captured in the document summary in JSON format.

FIG. 11D shows the process of selecting alternative clauses, for example, a payment clause which can incorporate alternatives such as a monthly subscription, annual subscription, lump sum, installments, milestone, or royalty, etc. The selected clause alternative and local variable (containing payment days and amount) is then hashed and sent to the blockchain through a representational state transfer application programming interface (REST API). The REST API is a software architectural style that describes a uniform interface between physically separate components, often across the Internet in a Client-Server architecture.

FIG. 11E shows the process of negotiation, whereby each party can edit the agreement, save their version, and exchange with the counterparty. The saved file contains clause selections and variables in a protected manner. If a party chooses to free-form edit the agreement, the system can compare the final text to the standard and create a listing of differences. FIG. 11F shows the process of signing, certifying and verifying the agreement.

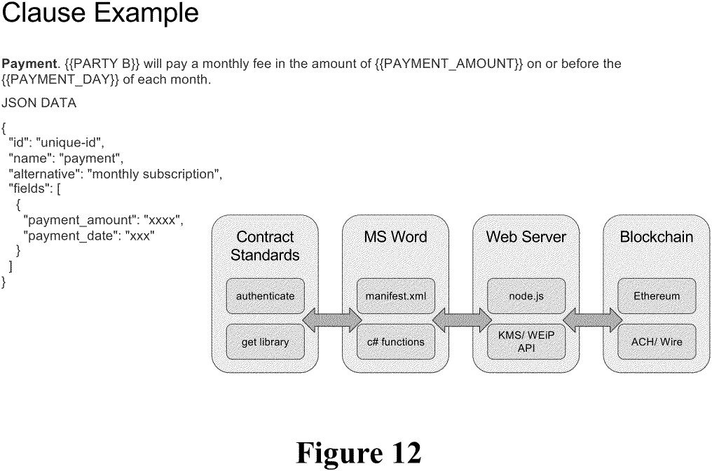

FIG. 12 is a diagram of a clause example of the present invention. In accordance with the preferred embodiment, the present invention uses a content library to collect and analyze agreements to detect certain patterns, such as a Levenshtein distance score between clauses (e.g., the clause example and the seed clause). This analysis serves as a starting point to creating a benchmark and a new editorially enhanced clause library for the present invention. As illustrated in FIG. 12, contract standards require authentication to access in a library, wherein the contract standards can be accessed through a word processing application such as MS word, and stored on a webserver on a blockchain network.

In one embodiment, the present invention uses a defined Ricardian exchange format to summarize agreements, listing: the overall match score compared to the standard (measuring any deviation); a list of clauses used; the match score for each clause compared to the standard; the global variables and values (e.g., party names); and local variables and values (e.g., payment amount, payment date).

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that may be included in the disclosed technology. The disclosed technology is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the technology disclosed herein. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

While the present invention has been described with reference to one or more preferred embodiments, which embodiments have been set forth in considerable detail for the purposes of making a complete disclosure of the invention, such embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention.

In the foregoing specification, the invention has been described with reference to specific examples of embodiments of the invention. It will, however, be evident that various modifications and changes may be made therein without departing from the broader spirit and scope of the invention as set forth in the appended claims.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

Any reference to “having”, “including” or “comprising” should be applied mutatis mutandis to “consisting” and/or “consisting essentially of.”

What is claimed is:

1. An apparatus for managing contract data, comprising:
at least one processing circuit configured to:
access contract data related to whether an action is permitted to be taken with the contract data, wherein the contract policy corresponds to a client version of a contract for the contract data that is maintained on the apparatus and is configured to be synchronized with a server version of the contract for the contract data that is maintained on a server;
make a determination to first attempt to communicate with a server in order to synchronize the client and server versions of the contract before acting to enforce the contract policy for the action;
attempt to communicate with a server in order to synchronize the client and server versions of the contract before acting to enforce the contract policy for the action in response to the determination to first attempt to communicate with a server in order to synchronize the client and server versions of the contract before acting to enforce the contract policy for the action, wherein synchronization of the client and server versions of the contract produces a synchronized client version of the contract by updating the client version of the contract to include one or more changes made to one or more contract policies in the server version of the contract that occurred after a previous synchronization of the client version of the contract with the server version of the contract; and
enforce the contract policy for the action based on the non-synchronized version of the contract in response to the attempt to communicate by the apparatus with a server being unsuccessful, wherein the at least one processing circuit is configured to access the contract policy by accessing a first contract policy related to a first contract in a first runtime and accessing a second contract policy related to a second contract in a second runtime, and wherein the at least one processing circuit is configured to enforce the contract policy by enforcing the first contract policy for the first contract executed in the first runtime and enforcing of the second contract policy for the second contract executed in the second runtime, and wherein first and second fair and reasonable contract terms are established and included within said server versions of said contracts.
